(19) United States
(12) Patent Application Publication
(10) Pub. No.: US 2026/0105344 A1
(43) Pub. Date: Apr. 16, 2026

(54) Quantum-Ready Multi-Model AI Truth Synthesis Engine with Bias and Poisoning Detection

(71) Applicants: Andrew Vance, New York, NY (US); Taylor Rodriguez Vance, New York, NY (US)

(72) Inventors: Andrew Vance, New York, NY (US); Taylor Rodriguez Vance, New York, NY (US)

(73) Assignee: Cyber Institute, New York, NY (US)

(21) Appl. No.: 19/247,914

(22) Filed: Jun. 24, 2025

(51) Int. Cl. G06N 10/60; G06N 10/20

(52) U.S. Cl. CPC G06N 10/60; G06N 10/20

(57) ABSTRACT

A quantum-compatible system and method are disclosed for synthesizing high-confidence, bias-resilient responses from multiple large language models (LLMs) using a dynamic orchestration and arbitration framework. A multi-LLM inference engine dispatches prompts in parallel to diverse LLMs, detects semantic divergence, and computes trust-weighted arbitration scores to generate a unified response. A bias and poisoning detection module adjusts model influence based on real-time risk metrics. An optional quantum routing architecture employs variational quantum circuits and entangled qubit measurements to optimize inference under high divergence. The system includes a feedback loop for continuous learning and trust recalibration, along with a secure, cryptographically verifiable audit trail. It operates across classical, hybrid quantum-classical, and federated edge environments, supporting explainable AI decision-making in sensitive domains such as law, healthcare, and cybersecurity. Drawing figures illustrate architecture, routing logic, bias detection, feedback mechanisms, and audit modules.

### BACKGROUND OF THE INVENTION

### Field of the Invention

The present invention relates generally to artificial intelligence systems and, more specifically, to systems and methods for implementing a multi-model inference engine that generates high-confidence responses across distributed large language models (LLMs). The invention further pertains to methods for mitigating bias, hallucination, and adversarial poisoning in AI-generated outputs through orchestration, statistical reconciliation, and dynamic routing mechanisms. The system is applicable in fields such as natural language processing, trustworthy AI, cybersecurity, quantum computing, and multi-agent systems.

### Description of the Related Art

Conventional artificial intelligence systems, including those employing large language models (LLMs), typically operate as standalone models or in limited ensemble configurations. In some cases, ensemble techniques aggregate outputs from multiple models using majority voting or static confidence thresholds. However, these systems lack dynamic orchestration and do not incorporate mechanisms for reconciling conflicting inferences based on output-level divergence, probabilistic arbitration, or real-time feedback and do not include capabilities for detecting or mitigating adversarial data poisoning, prompt injection, or embedded bias across distributed model outputs. Such systems are generally static in architecture and are not equipped to retrain or adapt based on feedback from internal inconsistencies or synthesis errors. Additionally, and critically, existing AI inference frameworks are not designed for compatibility with quantum computing environments. They lack the architectural support for quantum-enhanced routing, superposition-based model selection, or entangled inference logic. As quantum processors and hybrid classical-quantum systems become increasingly available, there exists a growing need for AI systems that can adapt to such platforms. No known prior art provides a multi-model AI truth synthesis engine that integrates quantum-compatible orchestration while addressing bias and poisoning resilience in real time.

### BRIEF DESCRIPTION OF DRAWINGS

FIG. 1 illustrates the system architecture of the Multi-Model AI Truth Synthesis Engine, including its core components: input ingestion module, multi-LLM orchestration layer, divergence detection engine, arbitration and synthesis logic, and final output generation framework.

FIG. 2 depicts the quantum routing architecture using a 2-qubit quantum circuit for arbitration control. The figure shows how different qubit measurement states correspond to routing strategies across LLMs based on trust scores and semantic divergence.

FIG. 3 illustrates the divergence detection and resolution process, including the computation of semantic similarity scores, outlier filtering, trust-weight rebalancing, and fallback arbitration logic.

FIG. 4 presents the feedback and self-training loop, showing how arbitration errors and low-confidence responses are used to dynamically update model trust weights and initiate fine-tuning procedures.

FIG. 5 depicts the bias and data poisoning detection pipeline. The figure includes filters for sentiment skew, demographic imbalance, adversarial injection patterns, and risk-based scoring models used during arbitration.

FIG. 6 illustrates the system's layered security and safety defenses, including mechanisms to detect and mitigate hallucinations, prompt injections, model poisoning, and adversarial outliers. It also shows how flagged outputs are quarantined or routed for additional scrutiny.

FIG. 7 shows the quantum orchestration embodiment, detailing the interplay between classical inference workflows and quantum decision logic via variational quantum circuits and entanglement-based routing.

FIG. 8 depicts the auditability and secure logging subsystem, including the generation of cryptographically linked hash chains, timestamped arbitration records, bias/poisoning flags, and role-based access controls.

### SUMMARY OF THE INVENTION

1. The present invention provides a system and method for synthesizing high-confidence responses across multiple large language models (LLMs) through a quantum-compatible orchestration framework. It coordinates inference from a plurality of distributed AI models, automatically detects divergence among their outputs, and synthesizes a unified response optimized for statistical reliability and semantic coherence via an arbitration engine (112).
2. The invention further includes mechanisms for detecting and mitigating the effects of output bias, prompt injection, and adversarial data poisoning. A bias and poisoning filter (110) evaluates each model output for indicators of sentiment skew, demographic bias, adversarial injection patterns, and semantic inconsistencies. This component performs multi-factor evaluation of each large language model (LLM) response using a combination of semantic analysis, statistical profiling, and anomaly detection techniques. Indicators such as sentiment skew, demographic or identity-based bias, adversarial trigger patterns (508), and semantic inconsistencies are extracted from output embeddings and compared against domain-specific and general-purpose trust heuristics.
3. Each detected artifact is assigned a severity score, and these are aggregated into a composite risk profile for the associated model output (301). The bias detection system (110) also integrates with the orchestration layer's feedback loop (part of orchestration module (106). Arbitration outcomes and low-confidence synthesis results (304) are logged and reprocessed to recalibrate trust scores and optionally trigger localized model fine-tuning or exclusion. This continuous evaluation mechanism ensures that the system maintains high inference integrity, especially in sensitive application domains such as legal analysis, healthcare guidance, or critical infrastructure monitoring. This profile contributes to dynamically adjusted trust weights (308).
4. Trust weights are assigned to each LLM response based on these factors, and unreliable outputs are either downweighted or excluded from synthesis by the arbitration engine (112). A feedback loop tracks arbitration errors and low-confidence results to recalibrate model trust profiles and optionally trigger fine-tuning procedures (408). Divergent or anomalous outputs are identified using ensemble scoring, trust weighting, and feedback-driven self-training mechanisms. Responses are routed through a configurable pipeline that supports both classical and quantum processing environments (701).
5. The architecture is designed to be quantum-ready, fully operable in classical and simulated quantum environments while architecturally compatible with future quantum execution models. In some embodiments, quantum decision logic is modeled using variational quantum circuits (VQCs) to guide model routing or arbitration when high semantic divergence is detected via a quantum router (206).
6. All core functionality is maintained without requiring quantum hardware, ensuring seamless deployment on conventional systems. Features such as quantum-inspired routing logic (712), superposition-based thread scheduling, and simulated entangled inference paths, where multiple model outputs are treated as interdependent decision states, enable future deployment in hybrid quantum-classical infrastructures. These capabilities position the system to evolve alongside advancements in quantum computing without sacrificing present-day performance or interoperability (701).
7. In one embodiment, the invention comprises a multi-threaded orchestration layer (106) that modularly manages input prompting, model invocation, divergence detection (108), and output synthesis across heterogeneous LLMs (110). In another embodiment, a quantum circuit (702) or simulator (204) supports routing decisions, consensus arbitration (704), or retraining prioritization using probabilistic sampling methods, such as those based on entropy (608) thresholds or historical trust scores (510). The system is designed for adaptability across various input domains and is particularly suited to high-integrity applications, including secure communications, legal analysis, scientific modeling, and critical infrastructure management.

### DETAILED DESCRIPTION OF INVENTION

### AI Policy Evaluation System

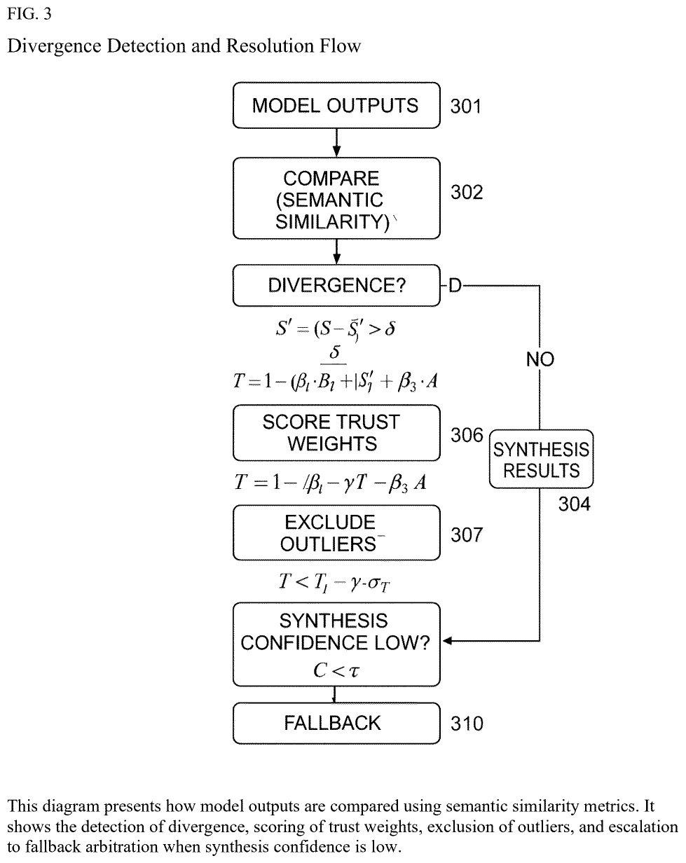

1. The Multi-Model AI Truth Synthesis Engine comprises a modular architecture designed to orchestrate inference across multiple large language models (LLMs), detect divergence or bias in their outputs, and synthesize a high-confidence unified response via the arbitration engine (112). The system is configured to operate across both classical and quantum-compatible infrastructures. The core innovation lies in the orchestration of heterogeneous LLMs, each with distinct training data, architectures, or inference behaviors, into a unified, coordinated processing pipeline managed by the orchestration module (102). This pipeline includes modular stages for input standardization, parallel model invocation, semantic divergence detection, confidence scoring, and consensus synthesis. Each module is dynamically configurable based on domain-specific requirements, risk profiles, or infrastructure constraints. By leveraging statistical and semantic alignment techniques, the system resolves inconsistencies in model outputs, enhancing reliability for high-stakes domains such as law, medicine, scientific modeling, and cybersecurity. An adaptive feedback loop, integrated within the orchestration layer (110), captures low-confidence events and anomalies, enabling continuous refinement through trust-weight recalibration and lightweight retraining.
2. To support reliable synthesis across diverse model outputs, the system incorporates quantitative mechanisms for evaluating semantic divergence and output trustworthiness. Pairwise semantic divergence between model outputs is computed using cosine similarity over contextual embeddings, yielding a divergence score δᵢⱼ that informs arbitration within the arbitration engine (112). Trust weights Wᵢ, derived from bias and poisoning risk metrics as detailed in the bias & poison filter (110), modulate the influence of each model's output. A composite arbitration score Aᵢ is calculated to determine which content segments should be prioritized in the unified response. If the maximum divergence across models exceeds a configured threshold Δ_{crit}, the system may escalate to fallback arbitration paths or, in quantum-enabled deployments, invoke a variational quantum circuit, via the quantum router (204), to assist with routing or consensus resolution. These mathematical evaluations operate as part of a dynamic feedback loop that adjusts model trust weights based on observed arbitration error, ensuring continual adaptation and resilience.
3. Referring to FIG. 3, the divergence detection system (301) evaluates model output variability through a semantic embedding generator (302) and a similarity scoring module (304). A threshold evaluator (306) determines if semantic divergence exceeds a configured limit. The system includes a vector analyzer (308) to compute cosine similarities and a divergence alert trigger (310) to initiate fallback logic when necessary.

### Quantum Ready Multi-LLM

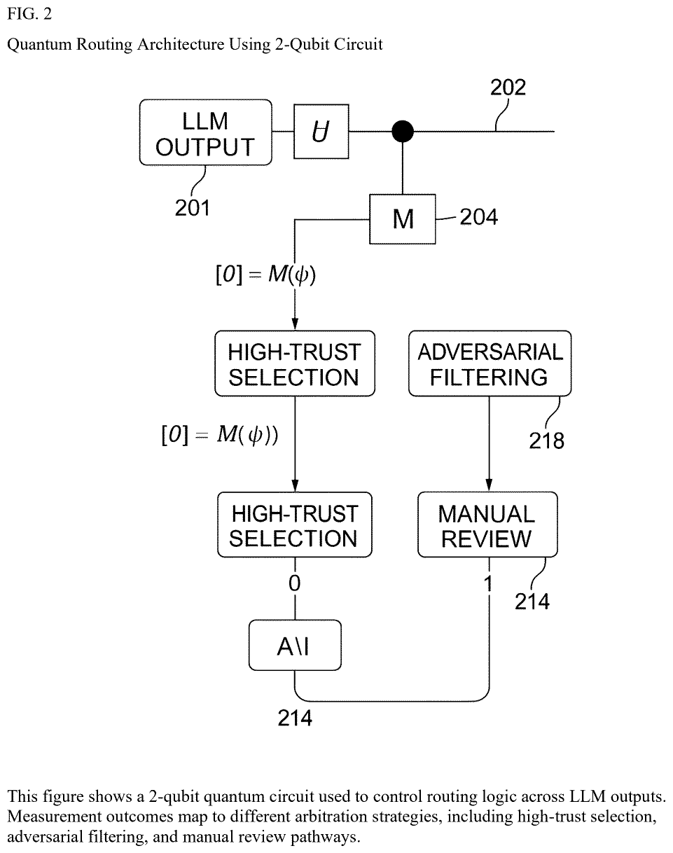

4. The system includes a quantum-ready orchestration framework designed to accommodate future integration with quantum computing environments. This framework supports both classical execution and hybrid quantum-classical inference processes. The orchestration layer (110) is structured to treat each model invocation, divergence detection, and arbitration (112) step as a routable computational unit that may be influenced by quantum decision logic via a quantum router. As illustrated in FIG. 2, the quantum routing circuit (204) facilitates this arbitration process through entangled state measurement outcomes. In one embodiment, routing decisions among multiple LLMs are modeled using qubit-based representations of model confidence, historical accuracy, and response entropy. These factors are encoded into a variational quantum circuit (VQC) that evolves under a parameterized Hamiltonian. As illustrated in FIG. 2, the quantum routing module supports probabilistic arbitration by incorporating a qubit state encoder (202), a variational quantum circuit processor, and a routing strategy selector (204). Trust-weighted entanglement parameters (208) are used to influence qubit preparation based on model behavior profiles. A measurement interpreter (210) decodes outcomes from quantum state collapses such as |00 [symbol] , |01 [symbol] , |10 [symbol] , and |11 [symbol] to inform routing decisions among LLMs. The measurement outcomes influence model selection, weighting, or synthesis strategies within the classical pipeline coordinated by the orchestration layer (110). In quantum-configured embodiments, routing decisions are derived from a cost function of the form:

$${min}_{θ} ( H ( θ ) + λ {D}_{penalty} ( θ ) )$$

where H represents the entropy of model outputs, D_{penalty} encodes semantic divergence, and θ are tunable parameters of a variational quantum circuit (VQC). This optimization steers arbitration toward output paths that minimize uncertainty and divergence in multi-model inference, and
where θ represents tunable parameters in the variational quantum circuit, H(θ) is the entropy of model outputs, D_{penalty}(θ) encodes semantic divergence between outputs, and λ is a weighting coefficient that adjusts the influence of divergence in the cost function. This optimization steers arbitration (112) toward output paths that minimize uncertainty and divergence in multi-model inference.
5. The system optionally simulates quantum superposition to represent concurrent evaluation paths across LLMs, coordinated through the orchestration module (102). This allows the inference engine to conceptually explore multiple model outputs in parallel, optimizing final output synthesis based on global minima in divergence, bias, or entropy. Entanglement logic may also be used to identify non-obvious correlations among model outputs. For example, if two or more models consistently diverge in similar contexts, the system can treat their outputs as entangled states, enabling anomaly detection through observed phase or amplitude shifts in simulated circuits using the quantum router (204). In simulated quantum configurations, model evaluation may be abstracted as a superposition state:

$$\vert Ψ 〉 = {\sum }_{i = 1}^{n} {α}_{i} \vert {O}_{i} 〉$$

where |Oᵢ [symbol] is the output from the i-th model and αᵢ is a trust-weighted amplitude. This metaphorically captures concurrent evaluation pathways used in ensemble synthesis.
6. The system's quantum compatibility extends to supporting integration with quantum development frameworks such as Qiskit, Pennylane, or Braket. These interfaces allow the orchestration logic to be tested and deployed on quantum simulators or real quantum hardware when available (701). In such embodiments, the quantum router (204) may invoke quantum subroutines to resolve arbitration decisions (112), prioritize retraining feedback loops, or detect adversarial anomalies. This quantum-ready infrastructure ensures that the system is forward-compatible with the emerging class of quantum-accelerated AI workflows. It also enables novel use cases in fields where quantum simulation, probabilistic inference, or entangled logic are valuable for decision-making under uncertainty.
7. In one implementation, the orchestration framework was developed using Python and integrated with IBM's Qiskit simulator to emulate a 2-qubit routing circuit. The LLM ensemble consisted of OpenAI's GPT-4, Anthropic's Claude, and a locally hosted LLaMA model, each accessed via secure APIs. Quantum state preparation encoded model trust scores derived from historical arbitration outcomes (112), and measurement results influenced prompt routing during high-divergence queries. This configuration allowed the system to simulate entangled decision paths in a classical environment while maintaining compatibility for future deployment on quantum hardware. A prototype version of the quantum routing module (204) was developed using Qiskit Aer, where a parameterized variational quantum circuit controlled routing logic based on entropy and trust metrics. Measurement outcomes |00 [symbol] , |01 [symbol] , |10 [symbol] , and |11 [symbol] triggered different arbitration strategies. For example, a |01 [symbol] result activated adversarial model filters, while |10 [symbol] prompted fallback arbitration using additional LLM queries. While validated in simulation mode, the invention is designed for forward compatibility with IBMQ hardware. The routing logic mirrored the intended deployment on IBMQ backends, showcasing the system's quantum compatibility. This mapping enables decision branches that adaptively respond to model disagreement and output entropy.

### Anti-Bias and Data Poisoning

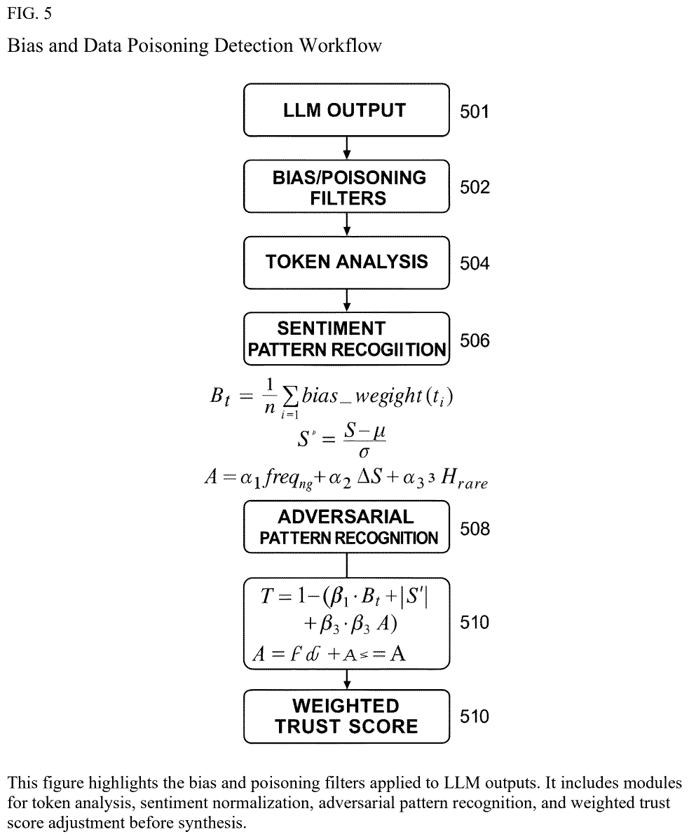

8. The invention includes a dedicated anti-bias and data poisoning mitigation layer implemented as a bias and poisoning filter (110), which operates between the model inference stage and the arbitration engine (112). This layer is responsible for detecting and correcting outputs that exhibit lexical, semantic, or statistical patterns indicative of bias, hallucination, or adversarial manipulation. In one embodiment, each LLM output is passed through a suite of filters that assess known indicators of harmful bias, including but not limited to: sentiment polarity skew, demographic or identity overrepresentation, repetition of known toxic phrase clusters, and inference entropy beyond acceptable thresholds.
9. A scoring mechanism assigns a bias score Bᵢ and a poisoning risk score Pᵢ to each model output Oi. These scores are used to weight or exclude outputs in the arbitration engine (112). The formula used may include:

$${W}_{i} = \frac{1}{1 + α {B}_{i} + β {P}_{i}}$$

where:
   Wᵢ is the trust-adjusted weight of model i
   alpha α and beta β are configurable sensitivity coefficients
This score is combined with semantic similarity scores and divergence measurements from the divergence detection module (108) to determine whether the output should be included in the synthesis process, adjusted, or discarded.
10. The system also maintains a dynamic blacklist and poisoning signature database within the bias and poisoning filter (110). When a new output resembles known poisoning vectors, such as prompt injection artifacts, chain-of-thought manipulations, or adversarial token patterns, it is flagged and traced back to the originating model for isolation or retraining.
11. In some embodiments, adversarial resilience is further enhanced by injecting known counterfactual test prompts and observing consistency across LLMs. Anomalous divergence or hyper-agreement may signal model-level bias or compromised behavior.
12. The bias and poisoning detection module (110) optionally interacts with the quantum router (206). For example, quantum-based anomaly detection can be applied by encoding a set of outputs into qubit registers and measuring the resulting interference patterns to detect non-classical correlations indicative of poisoning. This anti-bias architecture ensures the reliability and ethical integrity of the synthesized output, especially in high-stakes domains such as law, healthcare, and cybersecurity, where biased or adversarial information can cause material harm.
13. In FIG. 5, the bias and adversarial detection module (501) evaluates each output using a bias score calculator (502) and an adversarial detector (504). Outputs are passed through a semantic anomaly filter (506) and matched against a poisoning signature matcher (508). When risk indicators are high, a correction layer (510) either excludes the output or applies trust-weight downgrades for arbitration.

### Model Arbitration and Synthesis

14. The arbitration and synthesis module is responsible for reconciling the diverse outputs produced by the distributed LLMs into a single, high-confidence response. This module employs both statistical and semantic reasoning to determine which portions of each model's output should be trusted, weighted, and incorporated into the final synthesized result. In one embodiment, the system computes pairwise semantic distances D_{i,j} between all model outputs O₁, O₂, . . . , Oₙ, using cosine similarity over contextual embeddings or transformer-based attention pooling. The resulting similarity matrix is used to identify clusters of agreement and isolate outlier responses Each output is then assigned a composite arbitration score Aᵢ, defined by:

$${A}_{i} = {W}_{i} \cdot ( {\sum }_{j \neq i} sim ( {O}_{i} , {O}_{j} ) )$$

where:
   Wᵢ is the trust weight derived from bias and poisoning analysis
   sim (Oᵢ, Oⱼ) is the semantic similarity between outputs
   The synthesis engine (112) selects the most supported response segments and assembles them into a unified answer RRR, using a templated fusion model or language-level stitching techniques to ensure fluency and coherence.
15. In some configurations, the arbitration logic (112) accounts for historical model behavior, applying time-decayed trust profiles or penalizing repeated inconsistencies. When divergence exceeds a configured threshold δ, the engine may request additional model invocations via the orchestration module (102), flag the query for manual review, or generate a confidence-limited response with embedded uncertainty indicators.
16. For systems configured with quantum routing, arbitration logic (112) may be represented in a variational quantum circuit via the quantum router (204), where each model output is encoded as a quantum state. The interference and entanglement between states reveal dominant agreement regions or high-variance conflict zones, which are then used to inform classical synthesis decisions.
17. This arbitration framework enables the system to produce outputs that are not merely the average of model responses but are statistically and semantically grounded in the most trustworthy and coherent inferences available. It also enables graceful degradation in cases of extreme divergence and provides hooks for real-time human-in-the-loop escalation if configured.

### Feedback and Self-Training Loop

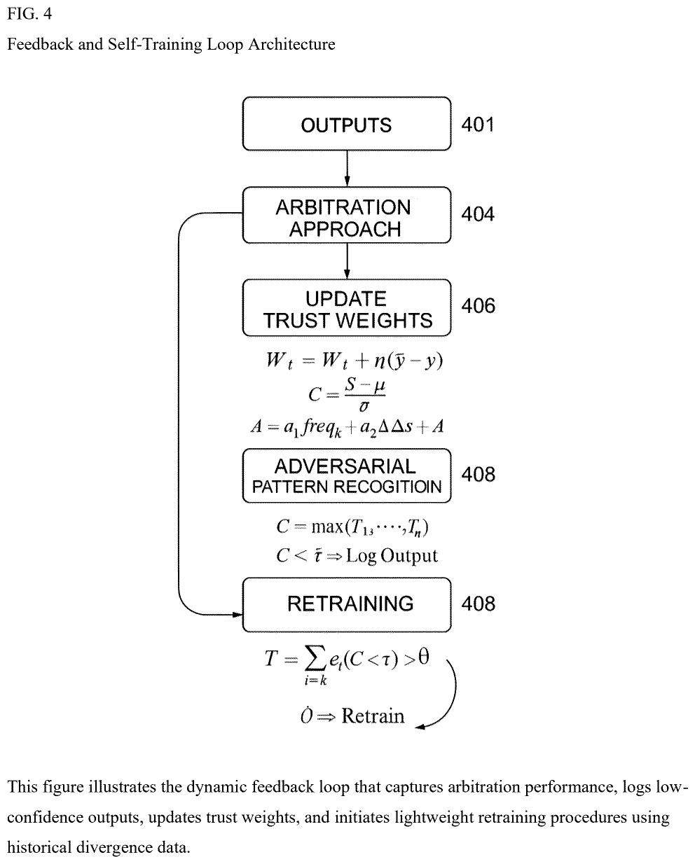

18. The invention includes an integrated feedback and self-training loop embedded within the orchestration module (106), which captures arbitration outcomes, divergence patterns, and synthesis errors to refine model behavior and system orchestration over time. This feedback system enables adaptive learning without the need for full retraining of constituent models, reducing compute costs while improving long-term accuracy and resilience. After each synthesized response is generated via the arbitration engine (112), the system evaluates: the degree of divergence across model outputs (from divergence detection 110), confidence of the final response, bias or anomaly flags raised during filtering, and external feedback (e.g., user validation, expert review).
19. When divergence exceeds a defined threshold Delta_{div}, or when repeated synthesis instability is detected, the corresponding input-output pairs are captured and stored in a retraining dataset. These cases are assigned diagnostic tags, including: semantic mismatch, bias reoccurrence, poisoning signature match, and unresolvable arbitration. The orchestration module logs these scenarios for downstream fine-tuning actions.
20. A lightweight fine-tuning framework periodically ingests this dataset to adjust trust weights, filter configurations (110), or if open-source models are used, selectively retrain specific model layers using parameter-efficient methods (e.g., LoRA, adapters, or reinforcement learning from disagreement). Formally, the update to a model's trust weight Wᵢ after divergence feedback may follow:

$${W}_{i}^{( t + 1 )} = {W}_{i}^{( t )} \cdot exp ( - γ \cdot {E}_{i} )$$

where:
   Eᵢ is the model's arbitration error rate in recent sessions
   γ is a configurable learning sensitivity factor
   and γ controls the influence of arbitration error Eᵢ on future trust updates within the orchestration logic.
21. In quantum-enabled deployments, the feedback loop may invoke quantum sampling via the quantum router (204) to explore alternative arbitration strategies or simulate entangled adjustments to model routing paths. This feedback mechanism also supports compliance and auditability. All flagged or unstable outputs are stored in a secure audit log (within or linked to 106), enabling downstream review and accountability in regulated environments such as healthcare, law, and critical infrastructure.
22. As shown in FIG. 4, the feedback and self-training loop (401) logs arbitration errors using an arbitration error logger and monitors synthesis consistency via a divergence monitor (404). A retraining dataset generator (406) collects flagged cases for incremental learning, while a trust update calculator (408) dynamically adjusts model weights. When instability is detected, a retraining trigger module activates selective parameter updates or model isolation.

### Quantum Routing Architecture

23. The invention includes an optional quantum routing architecture (201) designed to enhance model selection, arbitration (112), and divergence handling (108) through quantum-inspired or quantum-executed logic. This routing system operates in parallel to classical orchestration pipelines managed by the orchestration module and provides a probabilistic, entangled framework for managing inference flow between distributed large language models (LLMs). In one embodiment, a 2-qubit quantum circuit represents the routing state between three or more candidate LLMs. Each qubit encodes conditional weighting or trust profiles, while entanglement between qubits simulates correlated risk (e.g., when two models consistently produce high divergence on the same input class).
24. Quantum routing decisions are made based on the outcome of measurements from variational quantum circuits (VQCs), parameterized to minimize total expected inference entropy or maximize ensemble agreement. The VQC optimization process seeks values of θ:

$${θ}^{*} = arg {min}_{θ} 𝔼 [ H ( {O}_{i} ( θ ) ) ] + λ \cdot DivergencePenalty$$

where:
   H is entropy of model output
   λ is a divergence sensitivity coefficient
   When executed on real quantum hardware or simulators (e.g., Qiskit, Braket), the quantum circuit (202) returns measurement probabilities that map to dynamic routing decisions:
         |00 [symbol] : Use high-trust core models only,
         |01 [symbol] : Include adversarial filter models (110),
         |10 [symbol] : Trigger additional arbitration pass (112),
         |11 [symbol] : Flag for human-in-the-loop resolution.
25. The quantum routing interface (202) integrates with Qiskit and may operate in simulation mode for classical environments or real mode when connected to IBMQ, IonQ, or similar backends. In hybrid deployments, quantum decision modules are invoked only when classical arbitration confidence (112) falls below a specified threshold. This ensures efficient use of quantum resources while improving arbitration robustness in high-uncertainty inference scenarios.
26. The entanglement model within the quantum router (204) also enables higher-order analysis of divergence patterns across sessions. Repeated entangled state detection between specific model pairs can be used to dynamically update trust profiles or block certain LLMs from participating in arbitration (112) until retraining thresholds managed by the orchestration module are met.

### Security and Auditability Features

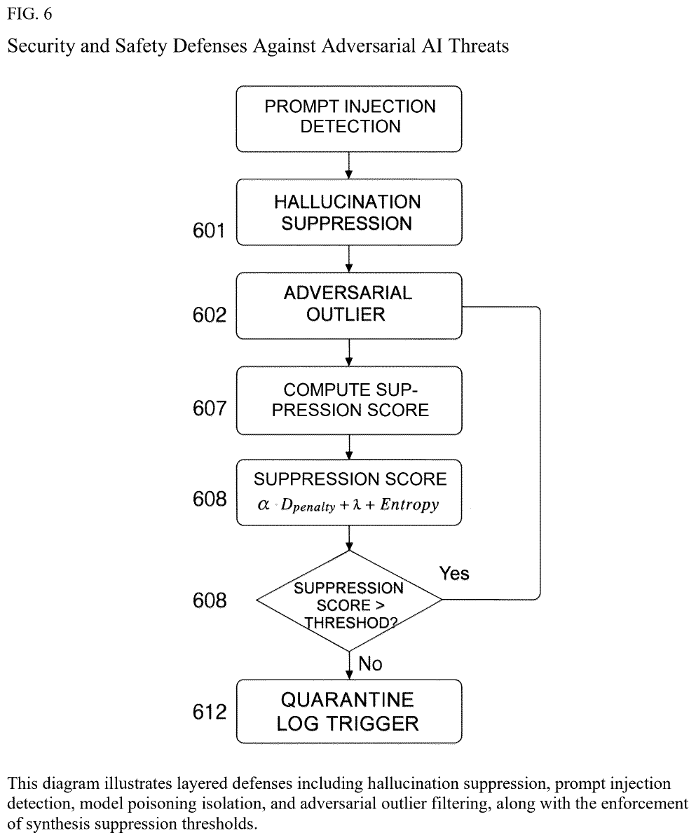

27. The invention includes a comprehensive set of security and auditability mechanisms designed to ensure the integrity, traceability, and resilience of the multi-model inference pipeline orchestrated via the orchestration module (110). These mechanisms protect against known threats to large language models (LLMs), such as prompt injection, model hallucination, adversarial data poisoning, and unauthorized inference manipulation. All inputs, intermediate outputs, arbitration states, and synthesized responses are logged in a cryptographically verifiable audit trail. This logging system optionally incorporates hash-linked audit chains, using SHA-256 or SHA-3 digests (804); timestamped arbitration logs (806) with divergence metrics (from 108); bias and poisoning flags per LLM invocation (110); and routing decisions (214) with associated entropy/confidence scores.
28. For adversarial detection, the system maintains an evolving threat model database implemented within or linked to the bias and poisoning filter (110), consisting of: known adversarial prompt vectors, injection token sequences, model-specific hallucination signatures, and unexpected high-confidence outputs with low ensemble support. Upon detecting a match, the inference process is either halted or routed to a quarantine arbitration path through the arbitration engine (112), with stricter thresholds or human review requirements. These mitigation strategies are enforced via configurable policies maintained by the orchestration layer (110), which may vary by domain (e.g., stricter thresholds for legal vs. general use).
29. In quantum-enabled deployments, quantum interference patterns may be analyzed through the quantum router (204) to detect abnormal coherence or phase behavior between model output states. Entangled output measurements deviating from historical patterns can indicate poisoning or synchronized adversarial attacks across model pairs. Additionally, the system includes role-based access controls (RBAC) and secure API gating (enforced at or via 104 and 106) to ensure that only authorized systems or users can invoke LLM orchestration, modify routing configurations, or access the arbitration log history.
30. These security and auditability features are designed to meet compliance standards, including NIST AI Risk Management Framework (AI RMF), ISO/IEC 42001 AI Management Systems, and high-assurance sectors such as healthcare, defense, and regulated critical infrastructure.
31. Referring to FIG. 6, the system's compliance and auditability architecture (601) includes a tamper-proof log writer (602), divergence risk auditor, role-based access manager, and encryption key controller. Each decision path is cryptographically logged via the compliance chain logger, ensuring traceability and enabling regulatory audit across high-integrity domains.

### Deployment Modes and Variants

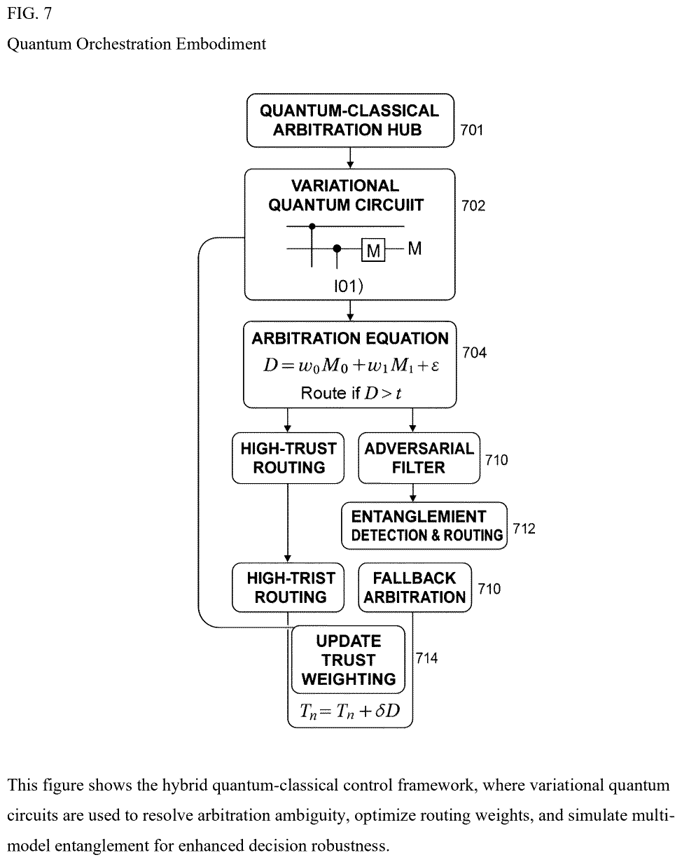

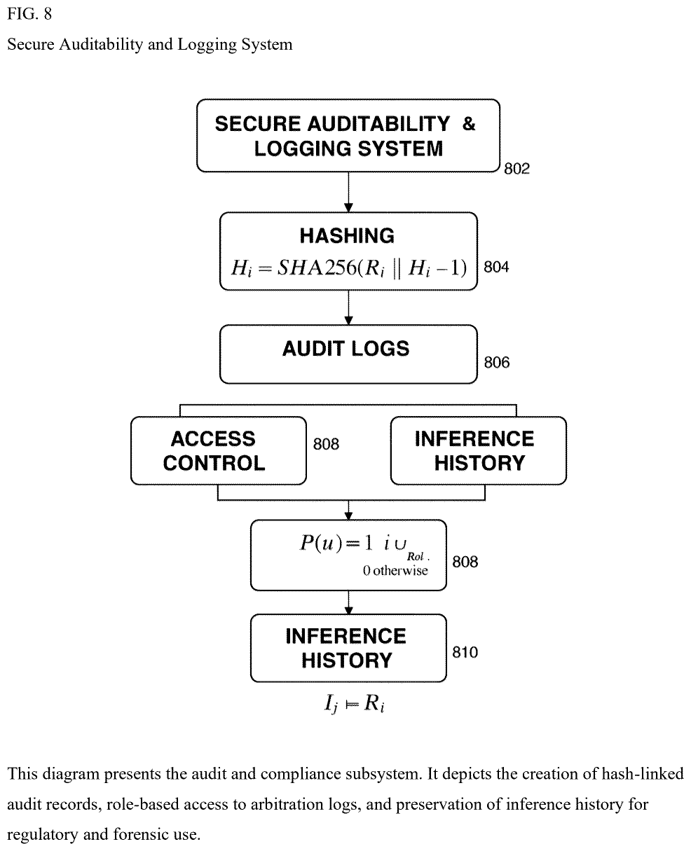

32. The architecture of the Multi-Model AI Truth Synthesis Engine is designed to support a variety of deployment environments, enabling broad applicability across industries and infrastructure types. The system can be deployed in fully classical computing environments, hybrid quantum-classical settings, or quantum-ready edge configurations. The invention supports the following primary deployment modes:
   Classical Centralized Deployment-All orchestration (102), inference, and arbitration (112) logic are executed within a centralized cloud or data center environment. LLMs may reside in containerized microservices or managed AI endpoints (e.g., via Hugging Face, OpenAI, or internal APIs). This mode uses the classical routing logic embedded in the orchestration layer (110) and is suitable for non-quantum deployments.
   Hybrid Quantum-Classical Deployment—Quantum routing logic is executed on a quantum simulator or real quantum hardware using a platform such as Qiskit or Amazon Braket. Model invocation and synthesis are performed classically via orchestration module (701), while decision arbitration (112) or divergence resolution (108) may use quantum-enhanced logic provided through the quantum router (206). This hybrid model allows for incremental testing of quantum modules before full integration.
   Edge Deployment (Quantum-Ready)—A lightweight version of the orchestration system is deployed at the edge (e.g., on secure embedded systems, air-gapped networks, or mobile field devices). This version includes pre-configured model bundles, arbitration logic (701), and a bias and poisoning filter (502). It is designed for environments with limited connectivity but high assurance requirements. Quantum routing is simulated or stubbed in this mode, but compatibility for future quantum updates is preserved.
   Federated and Distributed Deployment—Inference nodes (each hosting different LLMs) are distributed across a federated network. A central orchestration node (102) coordinates model invocation and synthesis. Each node locally logs inference events, including divergence metrics (304) and poisoning scores (508), and contributes to ensemble synthesis. This configuration is particularly suited for privacy-preserving use cases and sovereign AI infrastructures.
33. Each deployment mode includes configurable parameters for trust weight thresholds, model inclusion/exclusion rules (applied through 510), bias detection sensitivity, and retraining cadence. The architecture also allows automatic detection of the execution environment type and toggles quantum logic paths via the quantum router (204) accordingly. Deployment-specific configuration files and orchestration manifests (e.g., in YAML or JSON) enable reproducible infrastructure-as-code setups across cloud providers, hybrid environments, and secure enclaves.
34. As depicted in FIG. 7, the hybrid deployment framework (701) integrates edge inference nodes (702) with a centralized arbitration controller (704). A trust signal aggregator (706) collects weighted inputs, and a quantum sampling proxy (708) invokes quantum routing components (710) when classical arbitration confidence thresholds are not met.
35. In FIG. 8, the system's oversight infrastructure (802) includes a system-wide transaction logger, governance compliance interface (804), anomaly trace visualizer (806), and a historical synthesis validator (808). These components report to a cryptographic proof engine (810) that supports regulatory-grade audit trails, ensuring explainability and accountability in high-assurance sectors.

1. (System claim—Multi-Model AI Truth Synthesis Engine) A quantum-ready system for synthesizing high-confidence, bias-resilient responses from a plurality of large language models (LLMs), comprising:
(a) an input ingestion module (104) configured to receive user prompts;
(b) a multi-LLM orchestration engine (106) that dispatches said prompt in parallel to two or more LLMs, each of which generates an independent output;
(c) a divergence detection module (108) configured to evaluate semantic similarity among LLM outputs using vector embeddings and attention-based similarity functions, wherein the divergence score deltaᵢⱼ between models ᵢ and ⱼ is computed as:
$${Δ}_{ij} = 1 - cosine\_similarity ( {O}_{i} , {O}_{j} )$$
(d) a bias and data poisoning mitigation module (110) configured to assign a trust weight Wᵢ to each model output Oᵢ according to bias score Bᵢ and poisoning likelihood Pᵢ, computed as:
$${W}_{i} = \frac{1}{1 + α {B}_{i} + β {P}_{i}}$$
(e) an arbitration and synthesis engine (112) configured to compute an arbitration score Aᵢ for each output using:
$${A}_{i} = {W}_{i} \cdot ( {\sum }_{j \neq i} sim ( {O}_{i} , {O}_{j} ) )$$
and generate a synthesized output based on the highest scoring elements across all Aᵢ;
(f) an optional quantum routing module (204) comprising a variational quantum circuit (VQC) that simulates routing logic through entangled states |00>, |01>, |10>, |11>, where measurement outcomes determine arbitration routing strategy among LLMs;
(g) a feedback and self-training loop (part of 106) that captures arbitration error rates and low-confidence synthesis records to adjust Wᵢ via:
$${W}_{i}^{( t + 1 )} = {W}_{i}^{( t )} \cdot exp ( - γ {E}_{i} )$$
and optionally fine-tune model adapters or attention heads using labeled divergence data;
(h) a secure auditability and logging engine (within 106 and 112) that creates hash-chained logs of all model inputs, outputs, divergence metrics, synthesis decisions, and flagged anomalies for regulatory review.

2. (Method claim—Multi-Model Truth Synthesis Process) A method for orchestrating and synthesizing responses across multiple LLMs to generate a high-confidence answer, the method comprising:
(a) receiving a natural language prompt via an input interface (104);
(b) dispatching the prompt concurrently to a plurality of large language models using a multithreaded orchestration engine (106);
(c) computing semantic divergence among model outputs using vector embeddings and cosine similarity metrics (108);
(d) applying bias detection and poisoning filters (110) to each output, assigning dynamic trust weights based on observed risk factors;
(e) computing arbitration scores and synthesizing a final response by selecting content segments from the most consistent and trusted outputs (112);
(f) optionally invoking a quantum routing circuit (202) when divergence exceeds a predefined threshold Δ_{crit}, selecting a routing path based on entangled qubit measurement outcomes;
(g) capturing arbitration errors, rerouting failure states, and retraining configuration updates in a feedback loop (via 106); and
(h) recording all relevant data to a cryptographically verifiable audit trail (within 106 and 112) for compliance and explainability.

3. (Quantum-Enhanced Arbitration Routing) The system of claim 1, wherein the quantum routing module (204) includes:
(a) a 2-qubit circuit (see FIG. 2) parameterized via a variational algorithm;
(b) entanglement applied to encode correlated trust states across LLMs; and
(c) post-measurement routing logic that determines inference strategies based on qubit state outcomes, including: high-trust mode |00>, adversarial check mode |01>, fallback arbitration |10, and manual override |11>.

4. (Machine Learning-Based Bias and Poisoning Detection) The system of claim 1, wherein the bias anfed poisoning mitigation module (110) employs a transformer-based discriminator trained on adversarial datasets and uses token-level anomaly detection to dynamically flag outputs containing high-risk features (FIG. 5).

5. (Audit Logging System with Hash Chain Integrity) The system of claim 1, wherein the auditability engine (integrated with modules 106 and 112) generates immutable hash chains using SHA-3 for all inference sessions, including arbitration weights, model selection routes, and divergence thresholds, thereby ensuring traceable explainability and compliance (FIG. 6, FIG. 8).

6. (Edge or Federated Deployment Variant) The system of claim 1, further comprising a federated or edge deployment mode (see FIG. 7) in which individual LLMs execute on decentralized nodes, and arbitration is coordinated through a central synthesis node using secure model output aggregation and encrypted trust score transmission.

7. (Variational Quantum Optimization for Arbitration Confidence) The method of claim 2, wherein the quantum routing logic (204) includes optimization of a cost function:
$${θ}^{*} = arg {min}_{θ} ( 𝔼 [ H ( {O}_{i} ( θ ) ) ] + λ {D}_{penalty} )$$
where H denotes entropy of model outputs and D_{penalty} denotes a divergence-based penalty function (FIG. 2).

8. (Trust-Weighted Multi-LLM Inference Pipeline) A system as recited in claim 1, wherein model selection and synthesis are controlled by trust-weighted arbitration thresholds (406) that adapt in real-time based on feedback from human reviewers and divergence metrics, ensuring continuous learning (FIG. 4).

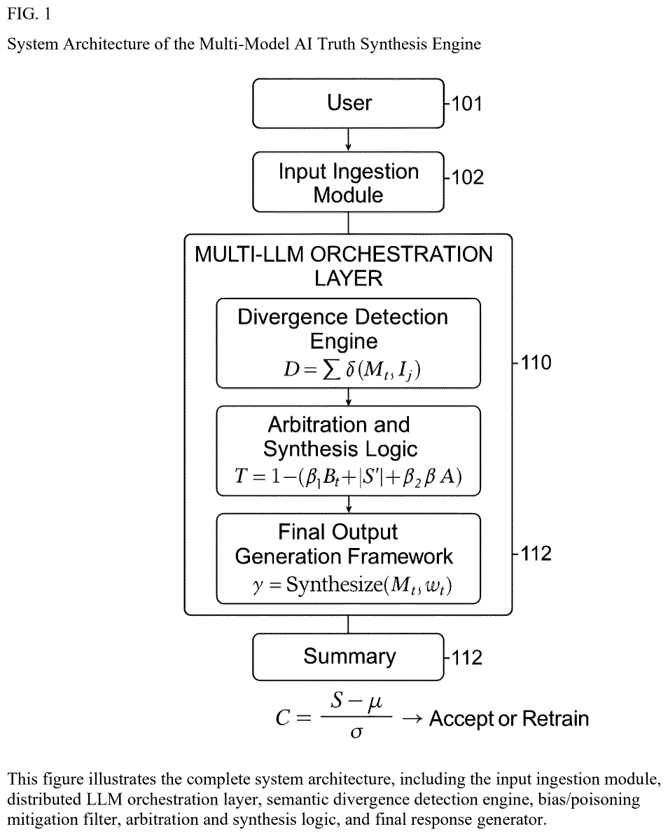

9. (Compliance with AI Governance Standards) The system of claim 1, wherein the audit log and synthesis decision record (110/112) are formatted to align with ISO/IEC 42001, NIST AI RMF, or comparable governance frameworks for ethical AI operation and cybersecurity assurance (FIG. 1).

10. (Classical Arbitration Variant) The system of claim 1, wherein the arbitration and synthesis engine (112) operate exclusively within a classical computing environment without invoking quantum circuits or quantum simulators (FIG. 1).

11. (Classical Routing Logic Alternative) The method of claim 2, wherein all inference routing, divergence detection (102), and arbitration decisions (112) are performed using classical algorithms and deterministic rule-based logic (FIG. 1), without reliance on quantum-inspired or entangled decision pathways (FIG. 2, optionally FIG. 7).
